(19) United States
(12) Patent Application Publication
(10) Pub. No.: US 2026/0155555 A1
(43) Pub. Date: Jun. 4, 2026

(54) V-MOUNT FOR ANTENNA ON TOWER OR POLE STRUCTURE

(71) Applicant: DAVID STANSBERRY, MURFREESBORO, TN (US)

(72) Inventor: DAVID STANSBERRY, MURFREESBORO, TN (US)

(21) Appl. No.: 19/337,717

(22) Filed: Sep. 23, 2025

Related U.S. Application Data
(60) Provisional application No. 63/698,014, filed on Sep. 23, 2024.

(51) Int. Cl. H01Q 1/12

(52) U.S. Cl. CPC H01Q 1/1235; H01Q 1/1207

(57) ABSTRACT

An apparatus for mounting one or more antennae to a cellular tower or monopole structure. A pair of V-mount bases are attached to the tower or structure, and two side V-frame weldments extend outward therefrom to a V-mount face frame. The V-mount face frame comprises two horizontal face tubes extending parallel to each other, with two vertical face braces extending therebetween. Two or more antenna mounting pipes are attached to the face and/or face extension tubes, and extend vertically above and below the face tubes. One or more stiff support arms may extend from the face frame to support points on the tower structure or other mounting apparatus.

This application claims benefit of and priority to U.S. Provisional App. No. 63/698,014, filed Sept. 23, 2024, which is incorporated herein in its entirety by specific reference for all purposes.

### FIELD OF INVENTION

This invention relates to a mounting apparatus for attachment of an antenna to a tower or pole structure.

### SUMMARY OF INVENTION

The present invention comprises an apparatus for mounting one or more antennae to a cellular tower or monopole structure. A pair of V-mount bases are attached to the tower or structure, each by two attachment brackets (for lattice tower attachment), or weldments for a mini-ring mount (for monopole attachment), and two side V-frame weldments extend outward therefrom to a V-mount face frame. Two V-mount bases, an upper and a lower, are used to support a V-mount face frame.

The V-mount face frame comprises two horizontal face tubes extending parallel to each other, with two vertical face braces extending therebetween. Face extension tubes may slidingly fit within the face tubes, and can be extended to increase the width of the face frame as needed. Two or more antenna mounting pipes are attached to the face and/or face extension tubes, and extend vertically above and below the face tubes. One or more stiff support arms may extend from the face frame to support points on the tower structure or other mounting apparatus.

The V-mount base comprises a compact swivel combo bracket that is attached to the front component of the attachment bracket with a boomerang plate attached to the upper surface thereof. The boomerang plate has a center bolt hole and an arc or curved slot or hole adjacent thereto, thereby permitting the boomerang plate to swivel to either side to a desired position, and then secured in that position by tightening the respective bolts (i.e., a pivot bolt and nut and an azimuth locking bolt and nut).

Each V-frame weldment has a rectilinear shape comprising a top pipe and a bottom pipe, each having a “rocket tab” with holes at their proximal ends for attachment to the respective ends of the boomerang plate with previously discussed hex bolt assemblies and each pipe is attached to a vertical front pipe at their distal ends. A solid rod extends between their proximal ends, and support rods extend from the respective corners of the weldment shape and meet or cross over in the middle. A short angle pipe extends through the vertical front pipe at an angle. The angle is set so that when the V-mount face braces are attached to the angled pipe and vertical front pile, the face braces and the horizontal face tubes (including any face extension tubes) are in the same plane, thereby providing a flat frame for mounting the antennae.

The V-mount face brace comprises a rectangular tube with holes at the ends to receive the horizontal face. A circular hole in the center receives the end of the short angle tube from the adjacent V-frame weldment. Oblong holes above and below the circular hole allow the V-mount face brace to be rotated on the short angle tube with respect to the adjacent V-frame weldment, and secured into a desired tilt position with hex bolt assemblies inserted through the holes. The V-mount face braces (along with the face tubes and antenna mounting pipes, and thus the antenna) thus can be tilted up to 7 degrees up or down.

### BRIEF DESCRIPTION OF THE DRAWINGS

FIG. 1 shows a V-mount apparatus for attachment to a lattice tower in accordance with an exemplary embodiment of the present.

FIG. 2 shows a V-mount apparatus for attachment to a monopole tower in accordance with another exemplary embodiment of the present.

FIG. 3 shows a detailed view of the V-mount base of FIG. 1 with two brackets, extendable face tubes, antenna mounts, and stiff arms.

FIG. 4 shows a detailed view of the V-mount base of FIG. 2 with mini-ring weldments, extendable face tubes, antenna mounts, and stiff arms.

FIG. 5 shows a detailed view of the V-frame weldment of FIG. 1 with extendable face tubes.

FIG. 6 shows a detailed back view of a swivel bracket and a boomerang plate, with V-frame weldments attached thereto, from FIG. 5.

FIG. 7 shows top views of the degree of swivel of the boomerang plate with respect to an attachment bracket.

FIG. 8 shows a detail of a face extension tube extending from a face tube, from FIG. 5.

FIG. 9 shows a detail of a V-mount face brace, from FIG. 5.

FIGS. 10-18 show examples of brackets for mounting to various types of tower member or components.

FIGS. 19-21 show views of a V-frame weldment with an angle pipe for insertion in the center hole of the V-mount face brace (FIGS. 20-30).

FIGS. 22-24 show views of a face tube used with face extension tubes.

FIGS. 25-28 show examples of fixed length face tubes.

FIGS. 29-30 show views of a V-mount face brace.

FIG. 31 shows the degree of tilting of the V-mount face brace when rotatably mounted on the angle pipe of the V-frame weldment.

FIG. 32 shows a view of an adjustable stiff arm with V-notch bracket for use on a lattice tower.

FIG. 33 shows a view of an adjustable stiff arm for a monopole tower.

FIGS. 34-37 show views of configurations for adjustable stiff arms.

FIGS. 38-39 show examples of antenna mounting pipes.

FIG. 40 shows an example of a sector frame mounted to a lattice/guyed structure.

FIG. 41 shows an example of a sector frame mounted to a monopole structure.

FIGS. 42 to 44 show examples of monopole mount configurations.

FIGS. 45-46 show details of a mini ring mount weldment.

FIGS. 47-49 show examples of fixed continuous face options with predrilled holes for antenna pipe and stiff-arm placement.

### DETAILED DESCRIPTION OF EXEMPLARY EMBODIMENTS

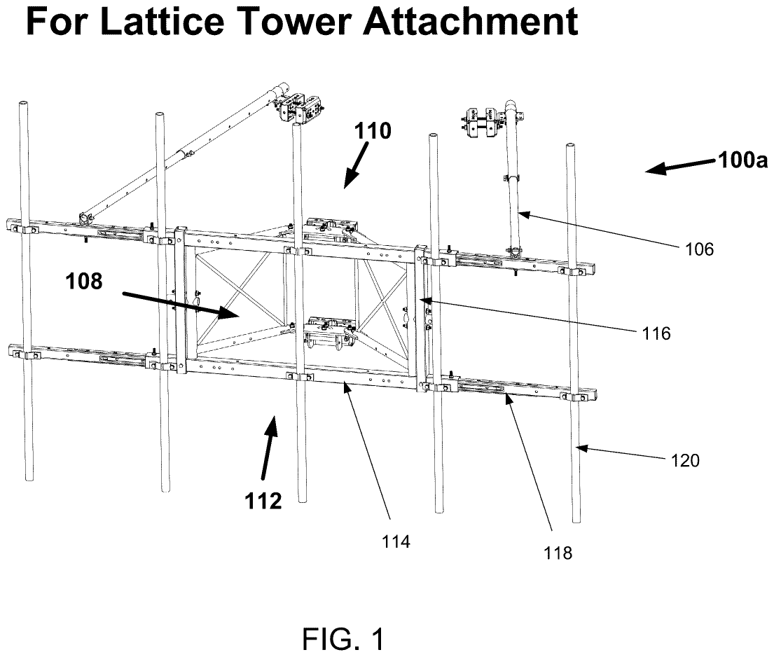

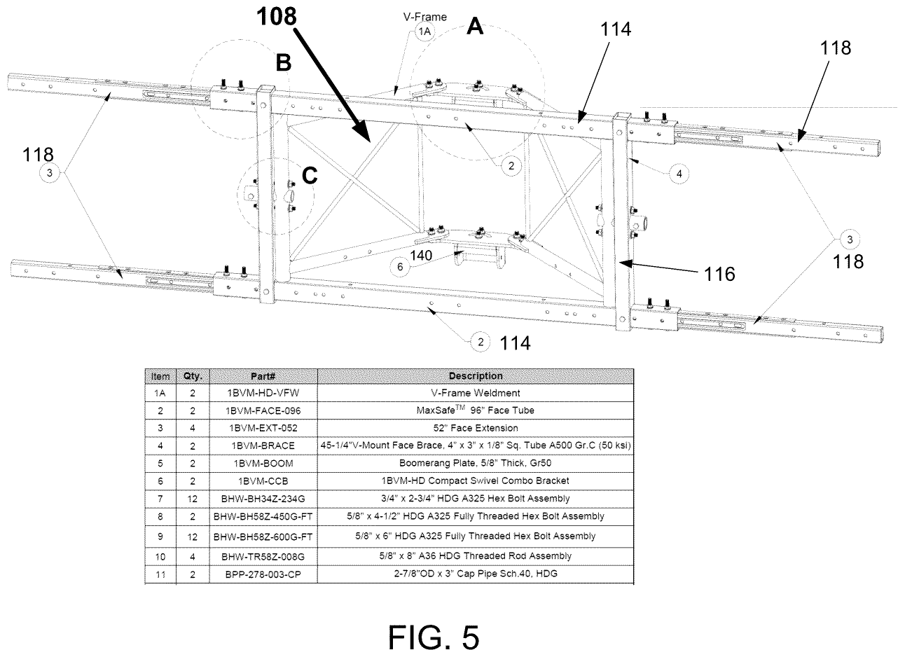

The present invention comprises an apparatus 100a, b for mounting one or more antennae to a cellular tower or monopole structure, as seen in FIGS. 1-5. A pair of V-mount bases 110 are attached to the tower or structure, each by two attachment brackets 102 (for lattice tower attachment), or weldments 302 for a mini-ring mount (for monopole attachment), and two side V-frame weldments 108 extend outward therefrom to a V-mount face frame 112. As seen in FIG. 1, two V-mount bases, an upper and a lower, are used to support a V-mount face frame 112, as described below.

The V-mount face frame 112 comprises two horizontal face tubes 114 extending parallel to each other, with two vertical face braces 116 extending therebetween. Face extension tubes 118 slidingly fit within the face tubes, and can be extended to increase the width of the face frame as needed. Two or more antenna mounting pipes 120 are attached to the face and/or face extension tubes, and extend vertically above and below the face tubes. One or more stiff support arms 106 may extend from the face frame to support points on the tower structure or other mounting apparatus. Various elements and components of the present invention are described in greater detail below.

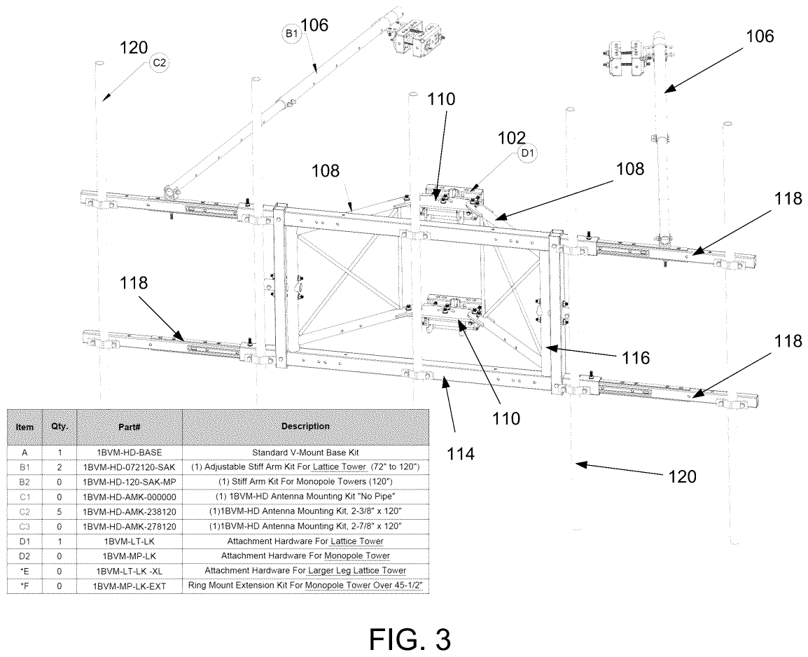

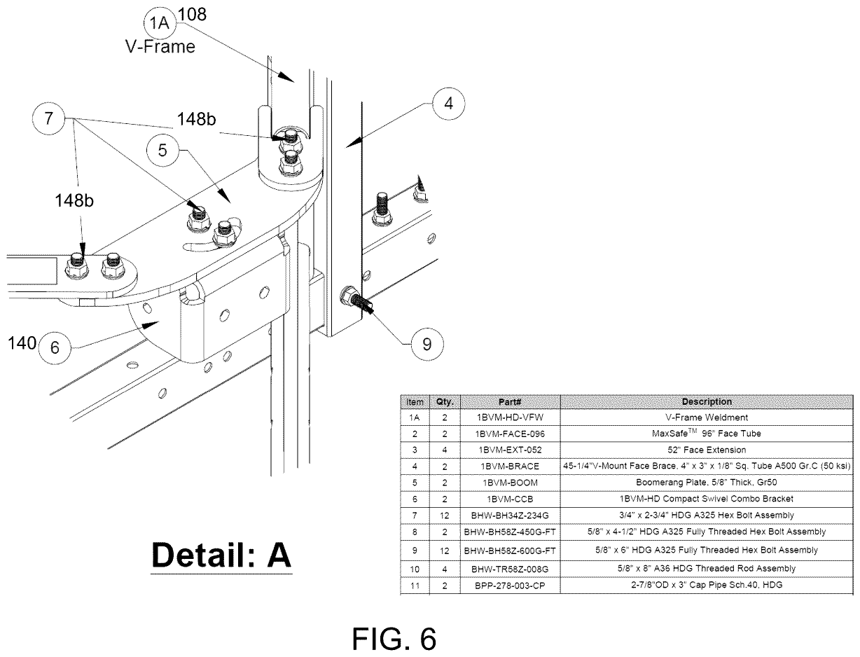

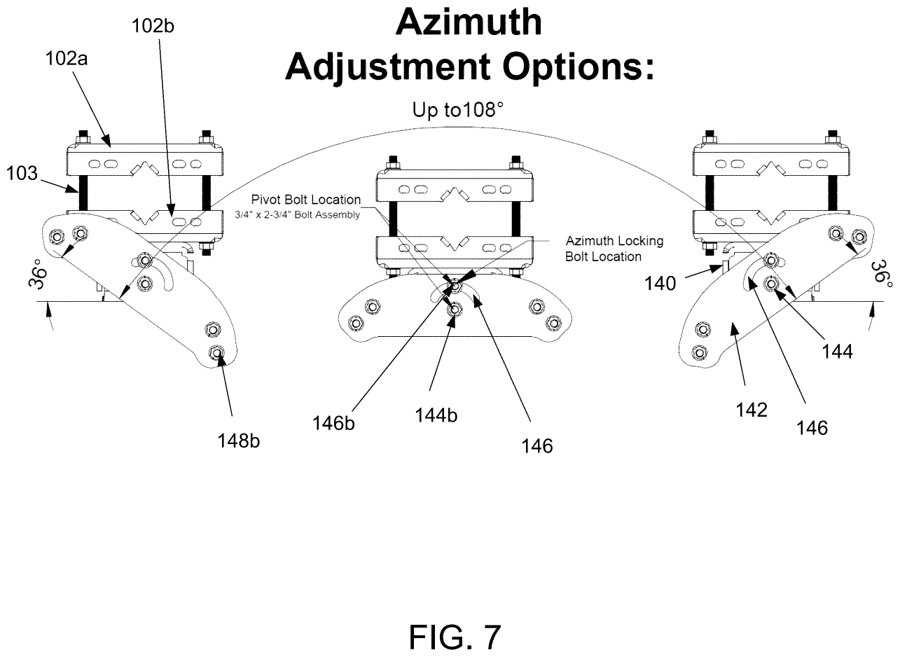

FIGS. 3 and 7 show an example of a pair of attachment brackets 102a, b, which may be V-notch brackets, with a front and back component that are secured around and to a tower leg or component with bolts 103 extending through each so that the tower leg or component is positioned therebetween the brackets. The V-mount base comprises a compact swivel combo bracket 140 that is attached to the front component of the attachment bracket with a boomerang plate 142 attached to the upper surface thereof. The boomerang plate has a center bolt hole 144 and an arc or curved slot or hole 146 adjacent thereto, thereby permitting the boomerang plate 142 to swivel to either side to a desired position, and then secured in that position by tightening the respective bolts (i.e., a pivot bolt and nut 144b and an azimuth locking bolt and nut 146b). The ends of the boomerang plate each mount one end of a V-mount side weldment 103 using a pair of hex nuts and bolts 148b insert in corresponding holes 148 as seen in FIG. 6. These hex bolt assemblies may be the same as the pivot hex bolt assembly 144b This permits the V-mount side weldments 103 and the face of the mount to swivel to allow azimuth adjustments for precise positioning of the antenna on the face of the V-mount. In the embodiment shown, the boomerang plate allows azimuth adjustments up to 36 degrees in either direction from a central or neutral position. It should be noted that this configuration shown does not allow vertical tilting of the boomerang plate or V-mount side weldments with respect to the attachment brackets or the tower leg or component. Tilting is provided by independent movement of the V-mount face braces, as described below.

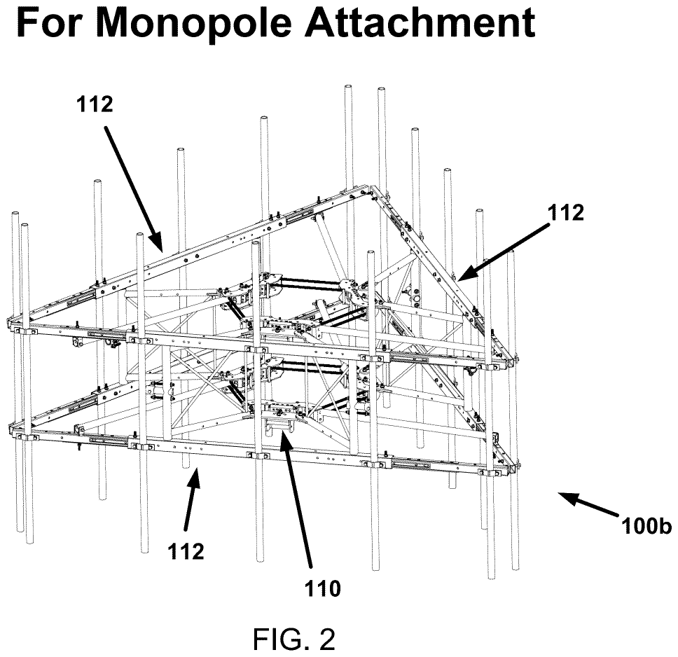

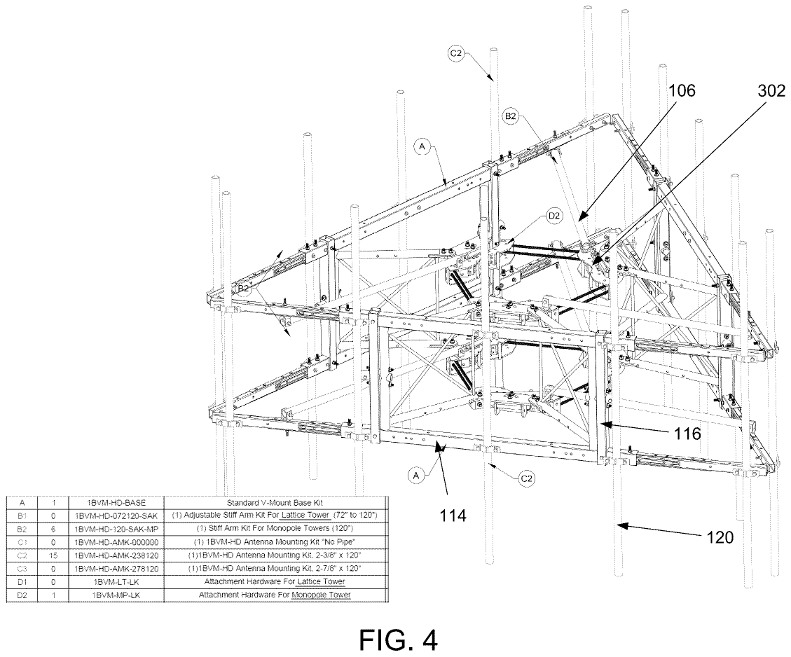

FIG. 4 shows a detailed view of the V-mount base and face frame structure of FIG. 2. The main differences between this structure and that for a tower, as seen in FIG. 3, are in the attachment means (i.e., mini-ring weldments) 302 used with a monopole tower structure (discussed below in more detail), and the placement of the one or more stiff support arms 106.

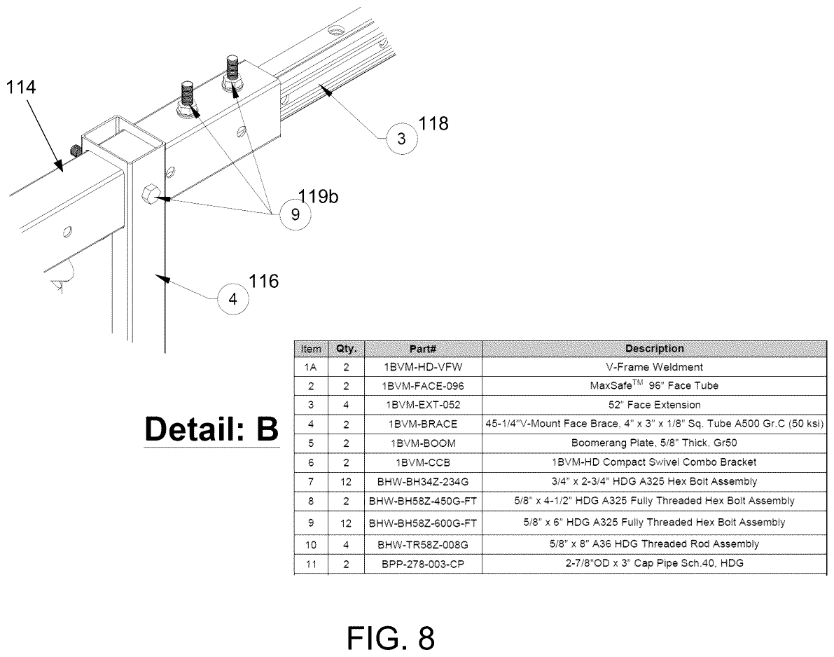

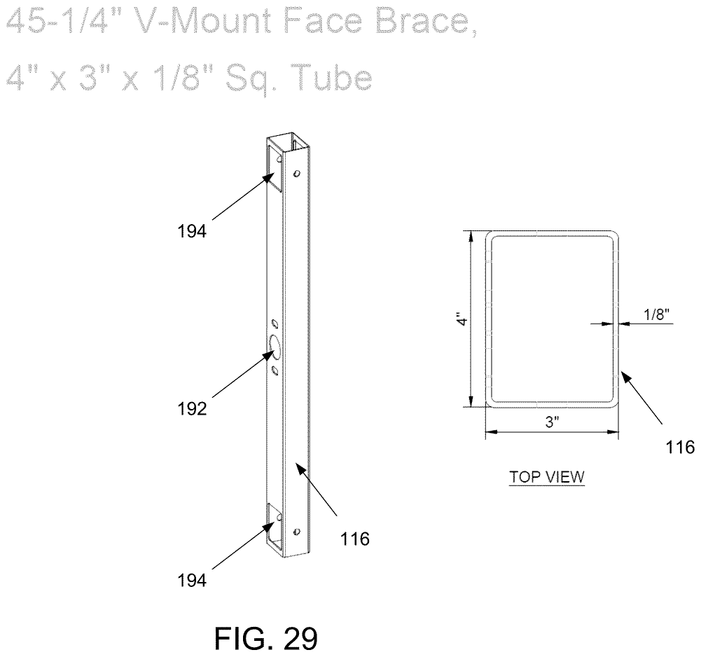

FIG. 8 shows a detail of a face extension tube 118 extending from a horizontal face tube 114. The horizontal face tube extends through corresponding holes 190 in the end of the corresponding vertical face tubes 116, as seen in FIG. 29, and secured thereto by hex bolt assembly 119b extending through corresponding holes in the side of the horizontal face tube and vertical face tube. The face extension tube 118b slidingly moves from and into the open end of the horizontal face, and can be secured by inserted of hex bolt assemblies 119b through corresponding holes in the respective tubes.

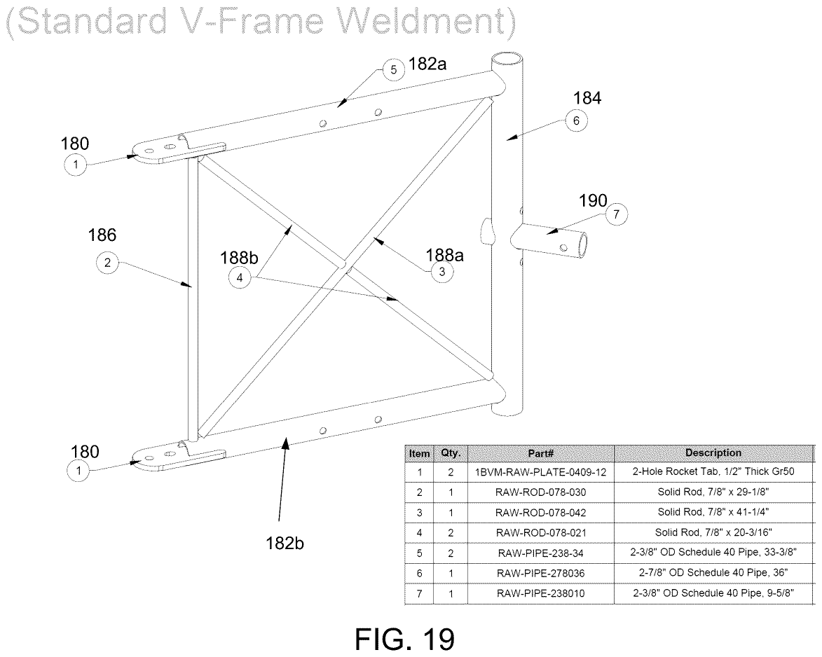

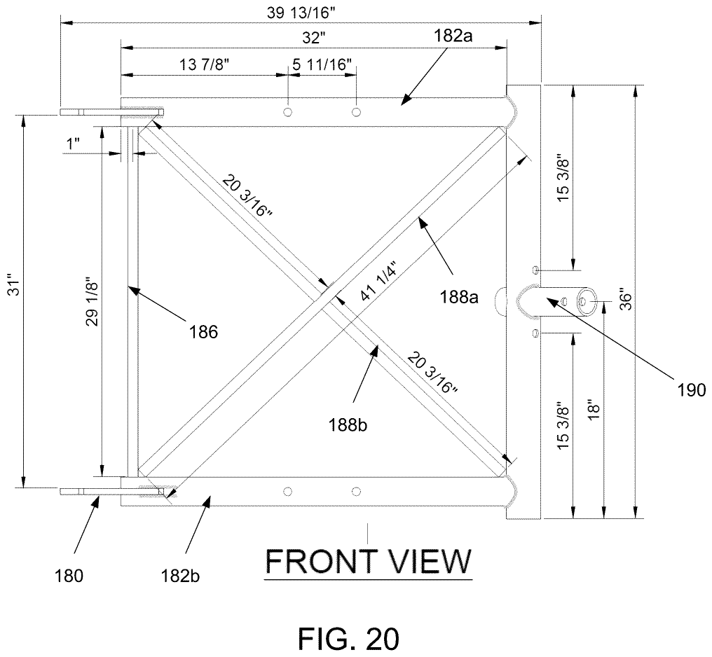

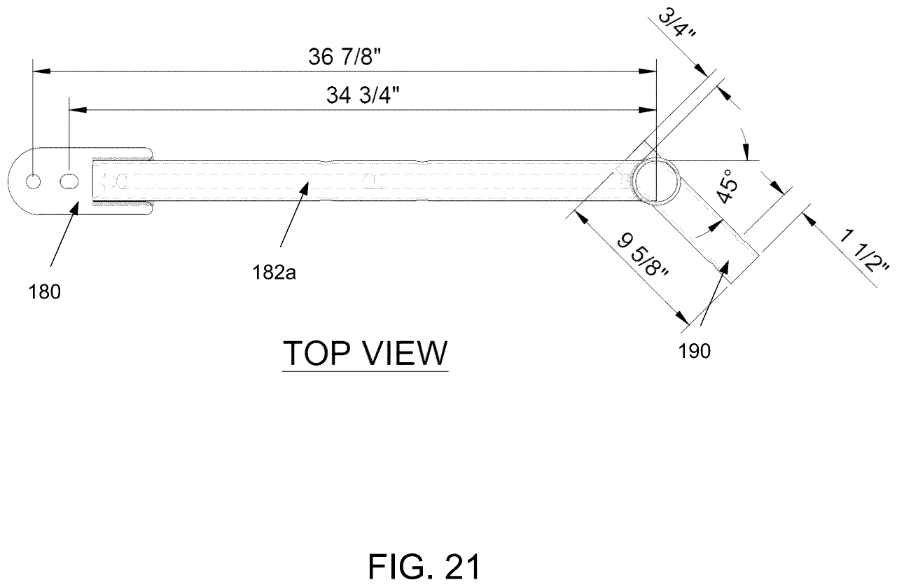

FIGS. 19-21 show in detail the components of a standard V-frame weldment 103. Each V-frame weldment has a rectilinear shape comprising a top pipe 182a and a bottom pipe 182b, each having a “rocket tab” 180 with holes 148 at their proximal ends for attachment to the respective ends of the boomerang plate with previously discussed hex bolt assemblies 148b. and each pipe 182a, 182b is attached to a vertical front pipe 184 at their distal ends. A solid rod 186 extends between their proximal ends, and support rods 188a, b extend from the respective corners of the weldment shape and meet or cross over in the middle. A short angle pipe 190 extends through the vertical front pipe 184 at an angle. The angle is set so that when the V-mount face braces 116 are attached to the angled pipe and vertical front pile, the face braces and the horizontal face tubes (including any face extension tubes) are in the same plane, thereby providing a flat frame for mounting the antennae.

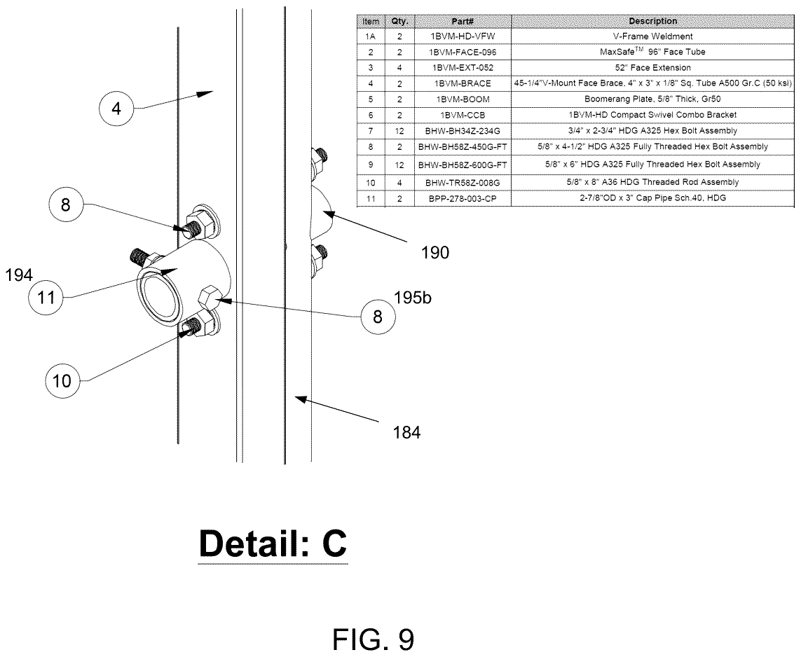

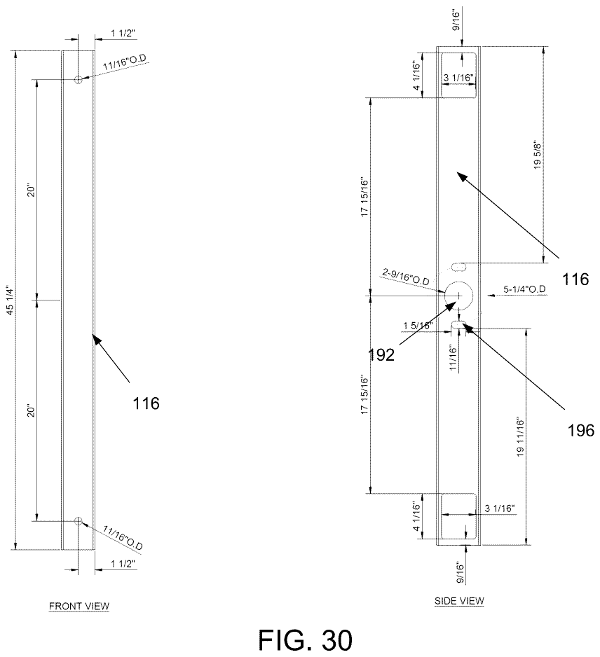

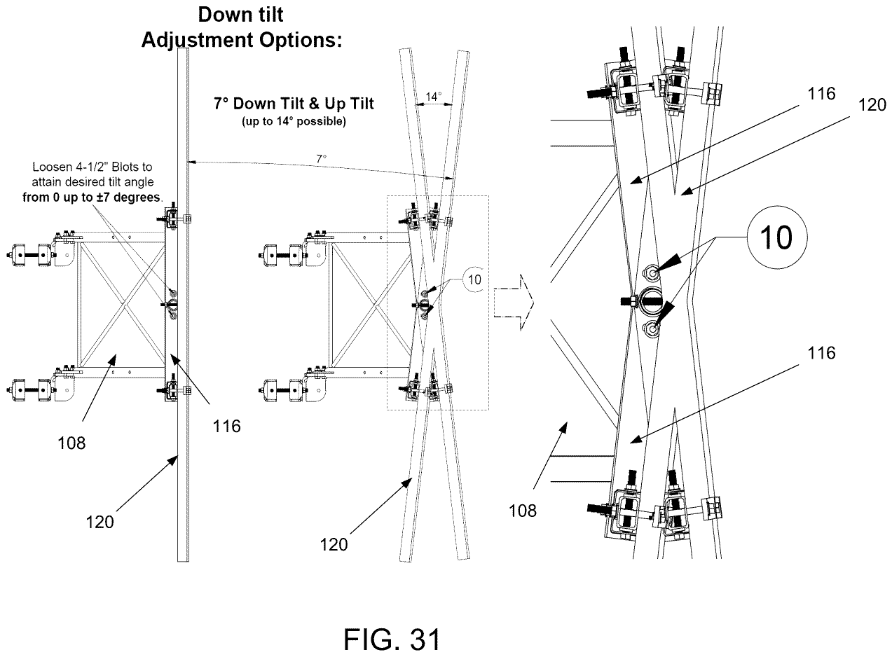

FIGS. 9 and 29-31 shows detail of the rotating connection between the V-frame weldment 103 and the V-mount face brace 116. The V-mount face brace comprises a rectangular tube with holes 194 at the ends to receive the horizontal face tubes 114 as described above. A circular hole 192 in the center receives the end of the short angle tube 190 from the adjacent V-frame weldment. A cap pipe 194 can be placed over the end of the short angle tube, and secured thereto by a hex bolt assembly 194b. Oblong holes above 196 and below the circular hole 192 allow the V-mount face brace to be rotated on the short angle tube with respect to the adjacent V-frame weldment, and secured into a desired tilt position with hex bolt assemblies inserted through the holes. The V-mount face braces (along with the face tubes and antenna mounting pipes, and thus the antenna) thus can be tilted up to 7 degrees up or down. The bolt holes are elongated and curved, allowing rotation of the face brace in either direction. When the face braces are at the desired tilt angle, the bolts are tightened, thereby securing the face braces and tubes at that desired tilt angle.

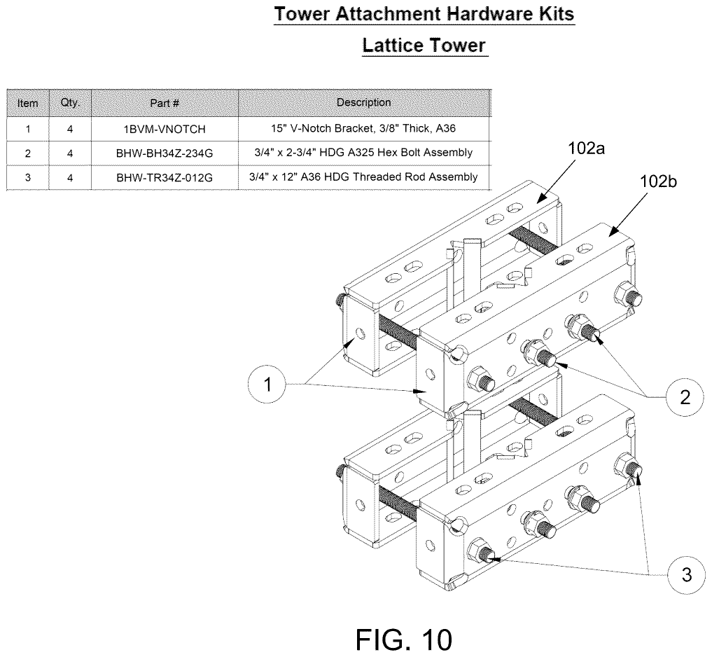

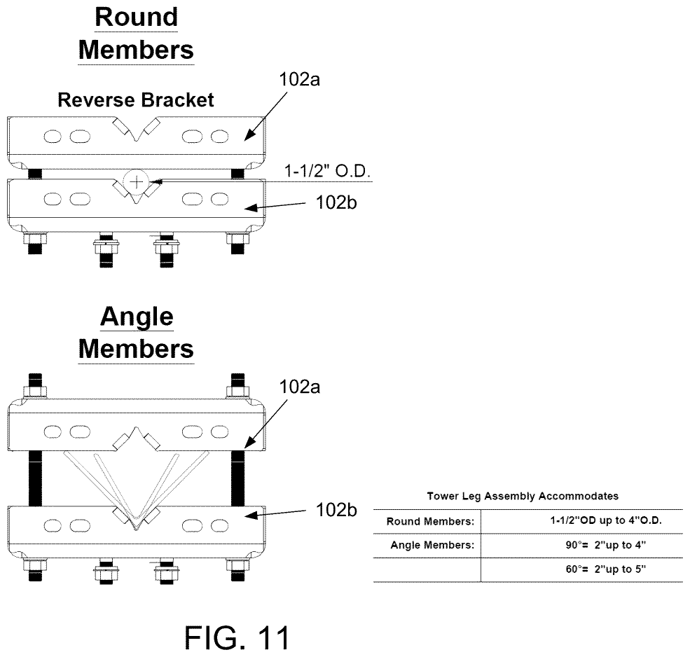

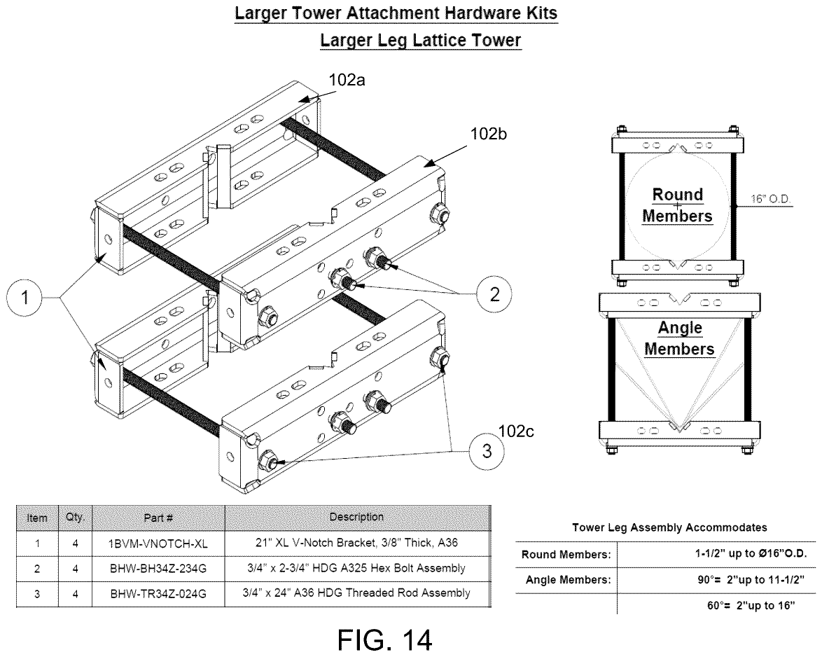

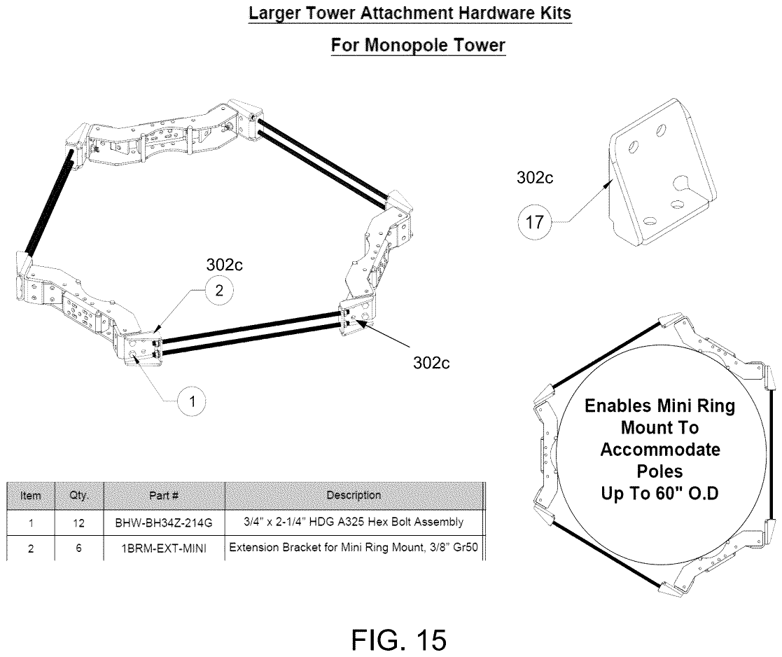

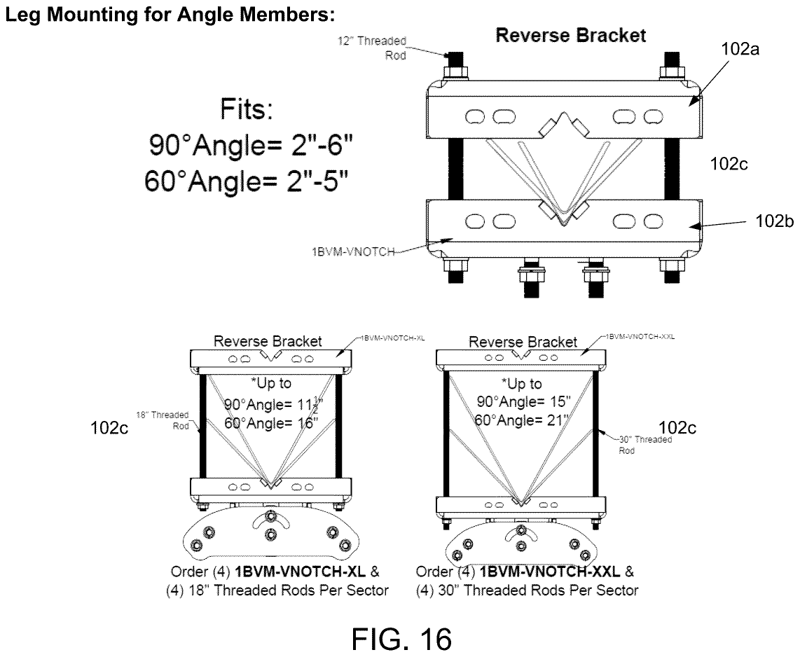

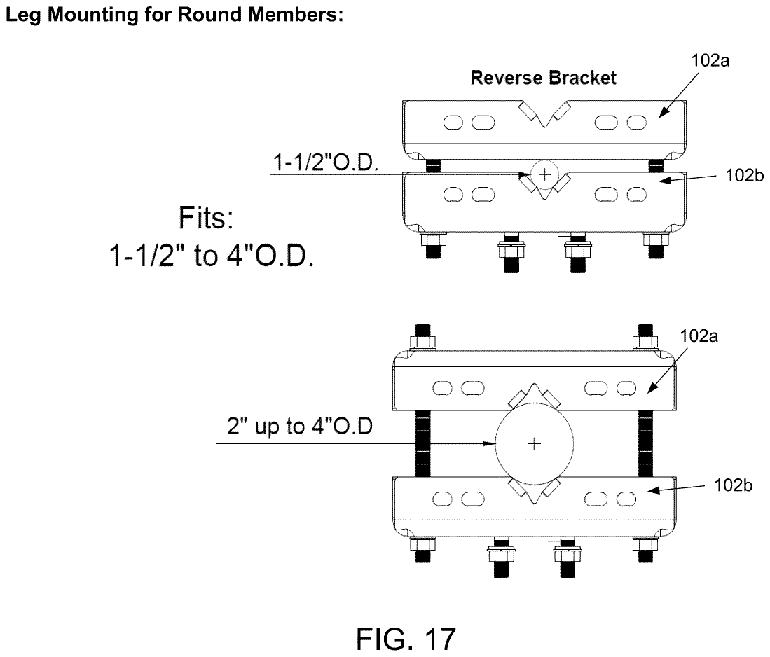

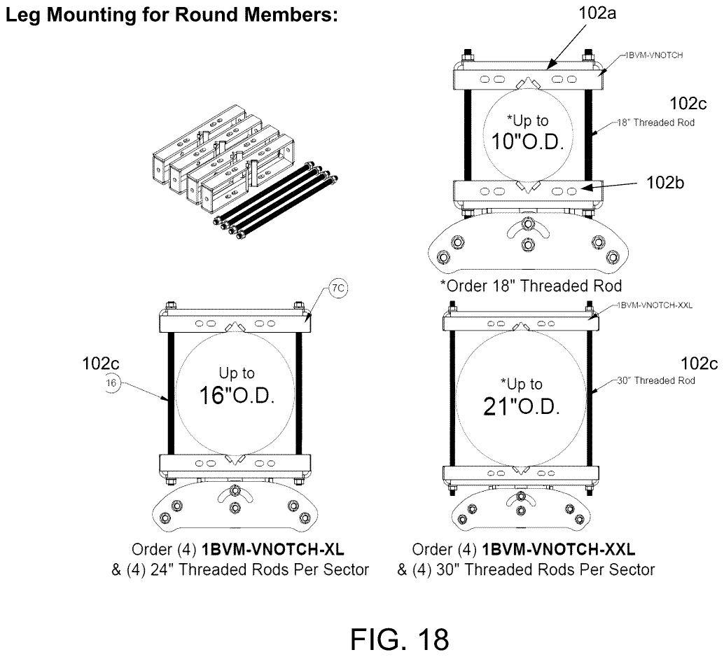

Several views of embodiments of attachment brackets 102a, b for lattice towers can seen in FIGS. 10-11, 14, and 16-18. The brackets can be arranged in different orientations, and with different sizes of V-notch, to accommodate different sizes and configuration of tower legs. The attachment brackets may be used with larger sized angle members or round members with the use of longer threaded rod assemblies 102c.

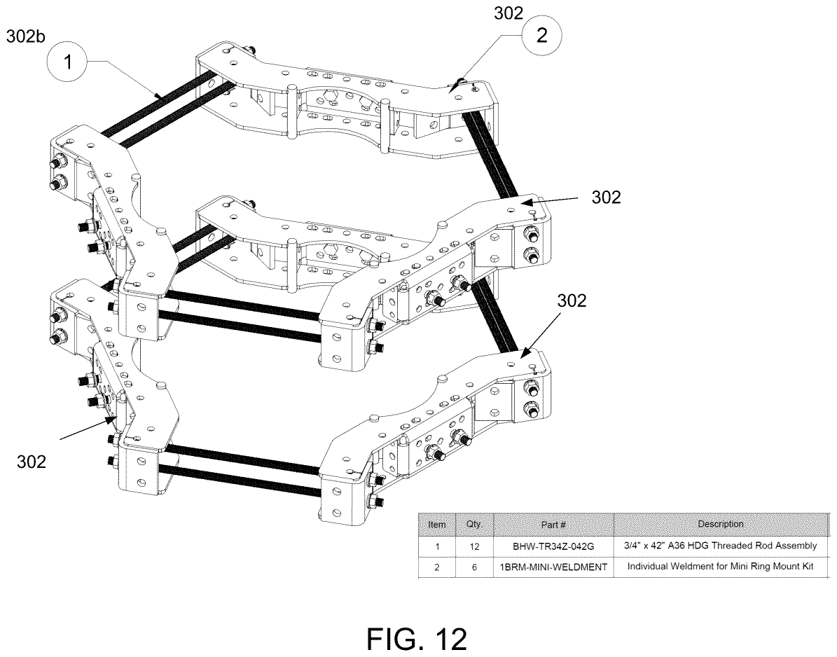

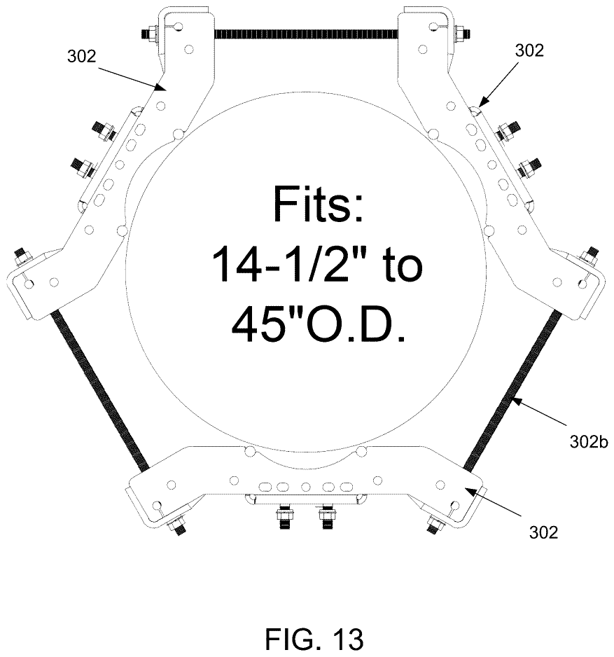

For monopole attachments, a series of individual weldments 302 are connected with pairs of threaded rod assemblies 302b to form mini-ring mounts, as seen in FIG. 12-13, and 15. Extension brackets 302c can secured to the ends of the weldments 302 by hex bolt assemblies to allow the mini-ring mounts to accommodate larger diameter poles.

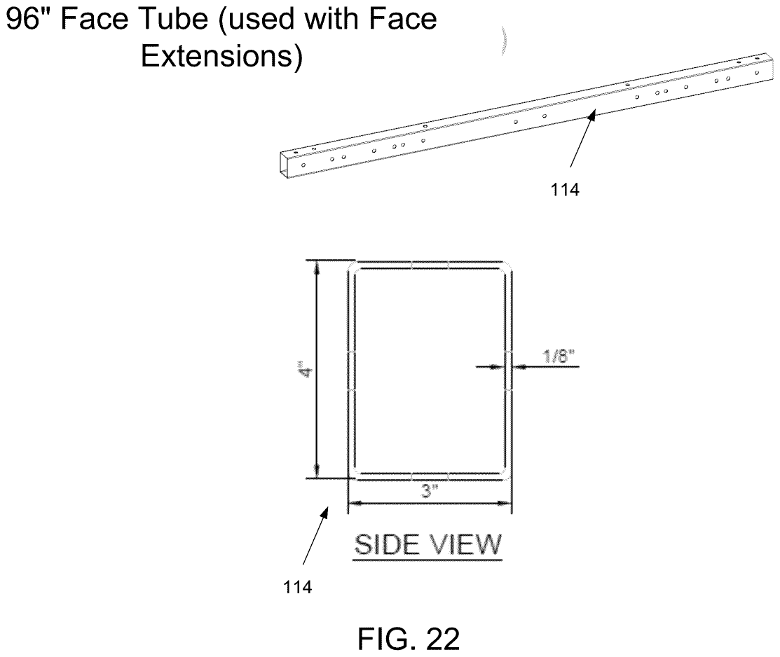

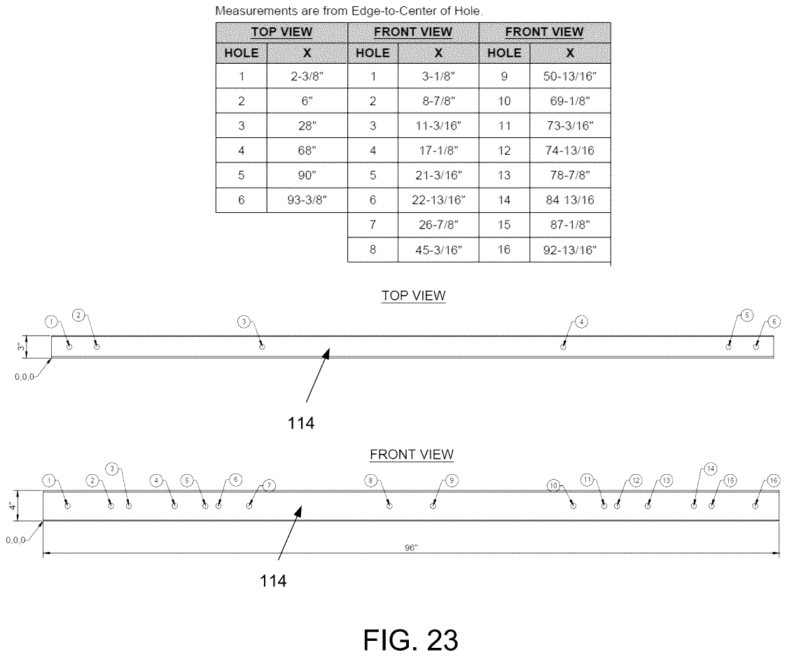

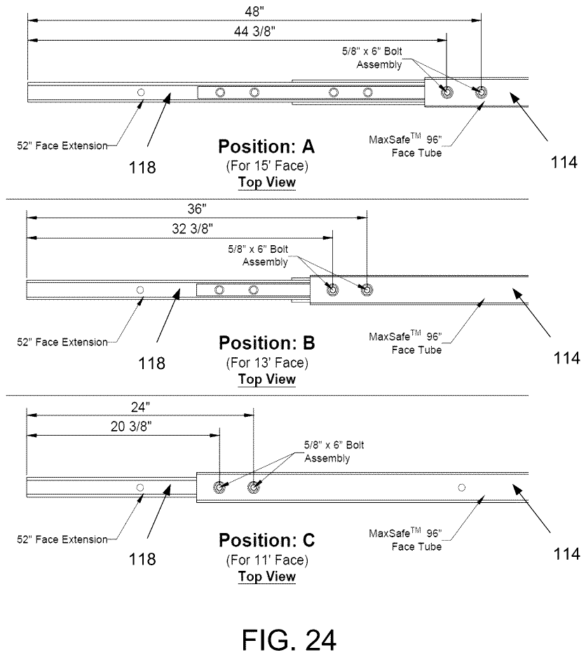

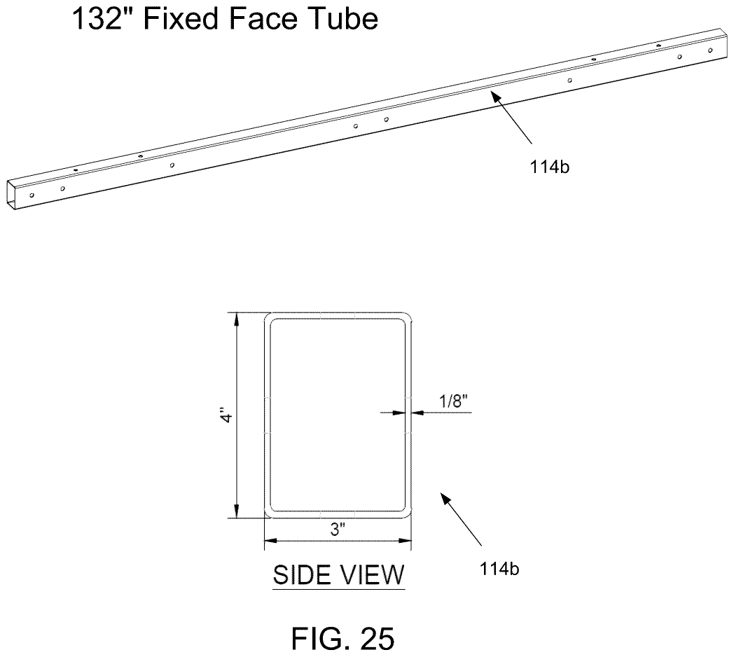

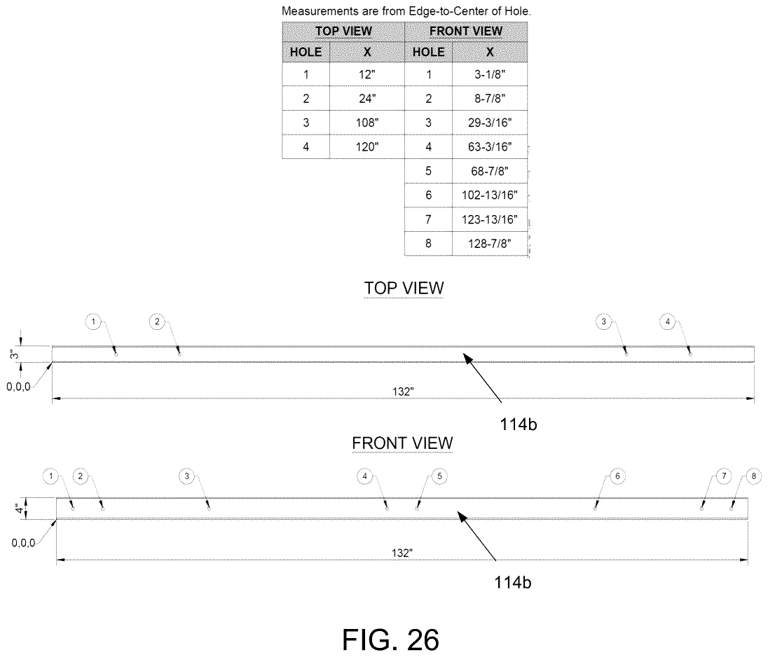

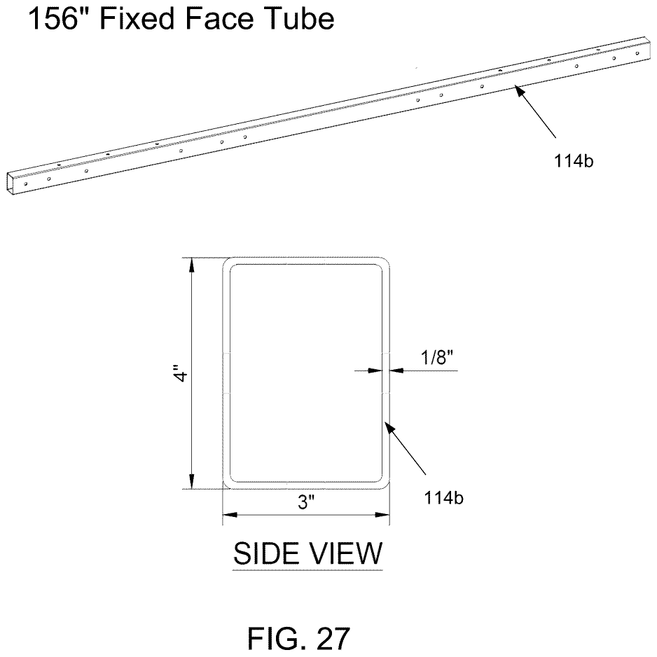

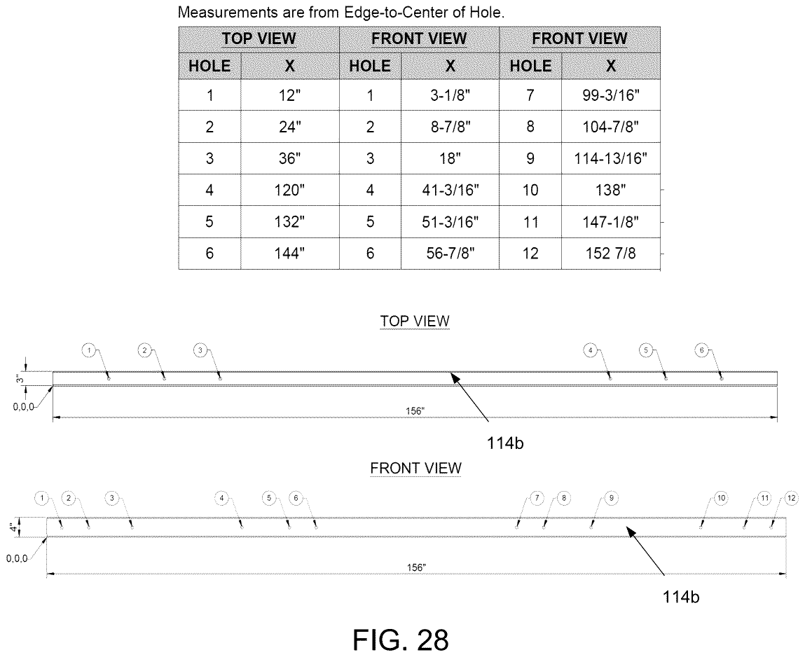

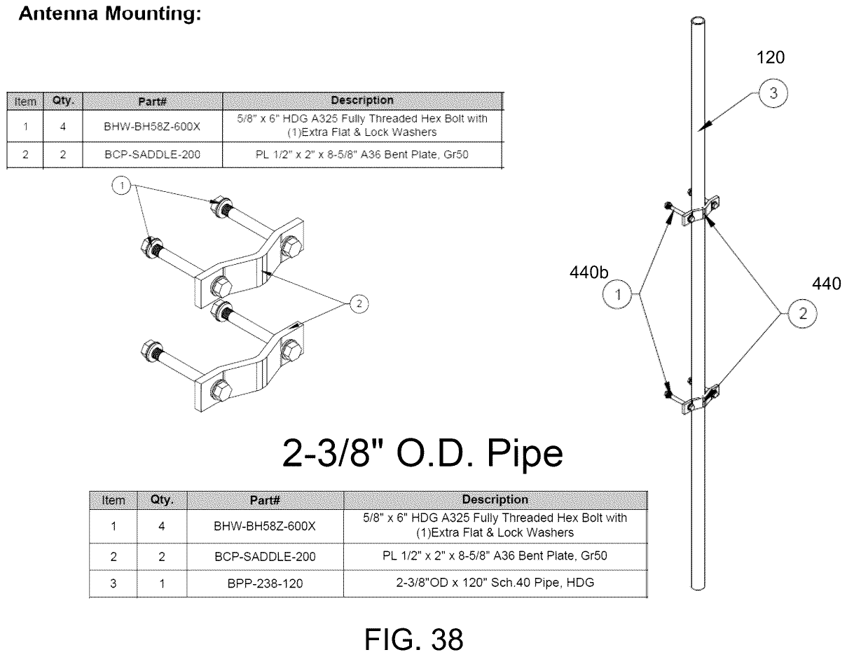

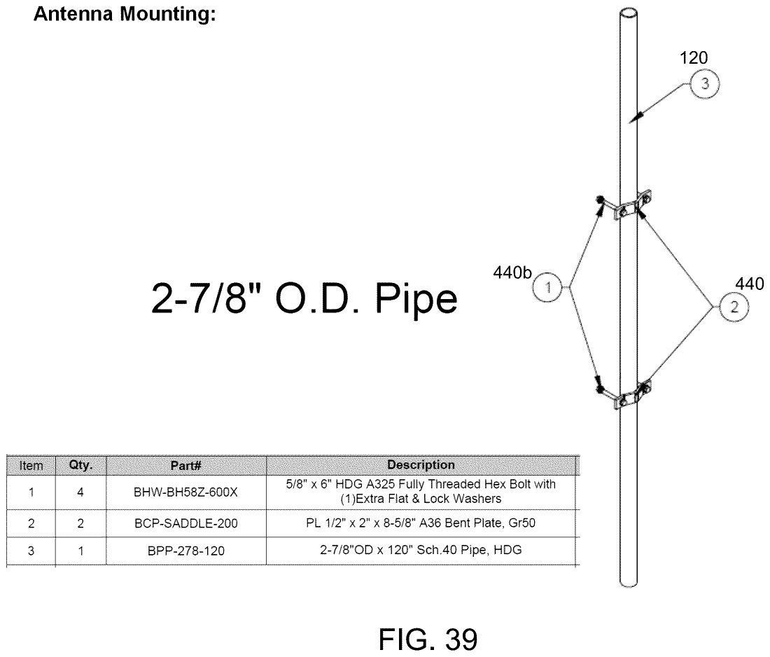

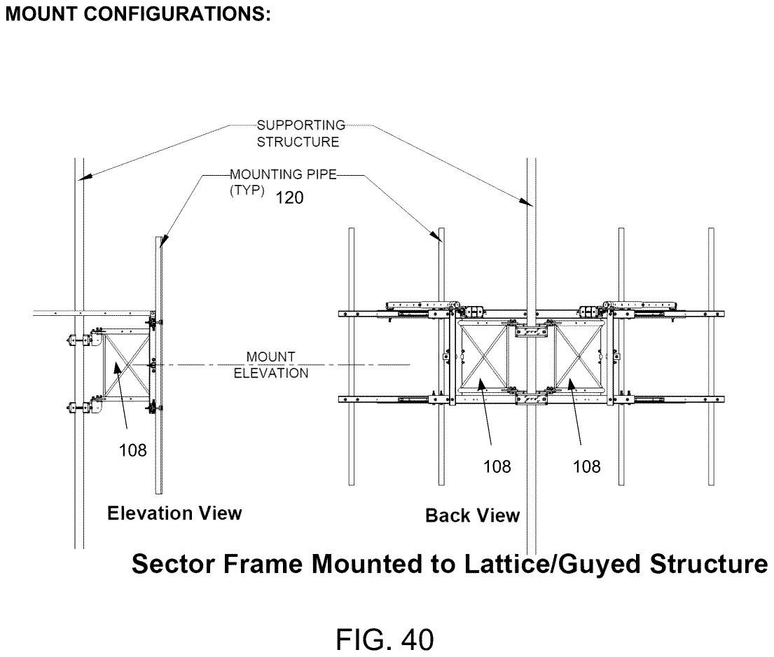

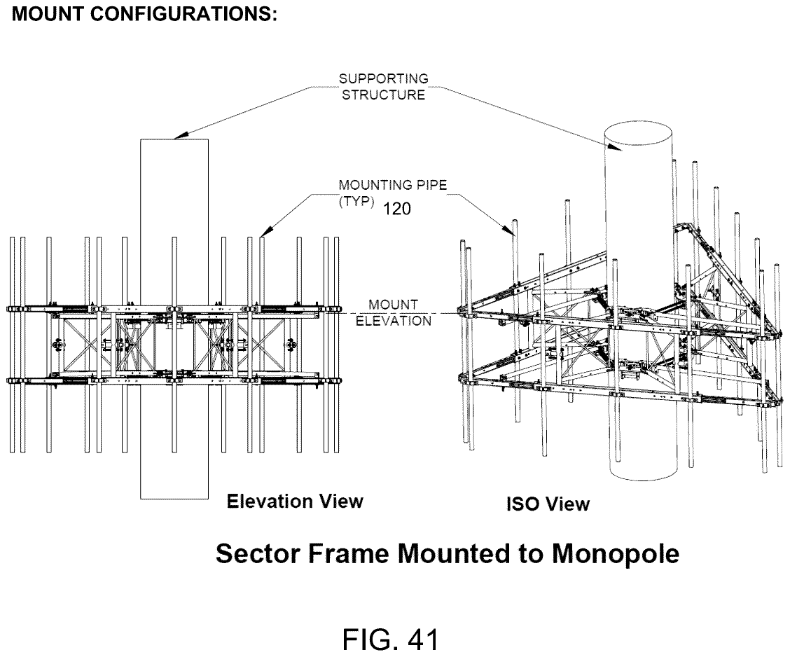

A series of antenna mounting pipes 120 are attached to the face tubes 114, 118, and extend up and down vertically to support and secure the antenna to the mount. FIGS. 22-22 shows various embodiments of face tubes with attachment hole configurations, some used with face tube extensions 118, while longer fixed face tubes 114b may also be used. FIGS. 38-41 show examples of antenna mounting pipes 120 and sector frames and supporting structures. Pipes 120 typically are secured to face tubes by means of a bent plate 440 and hex bolt assemblies 440b, which are used in conjunction with corresponding holes in the face tubes and other components.

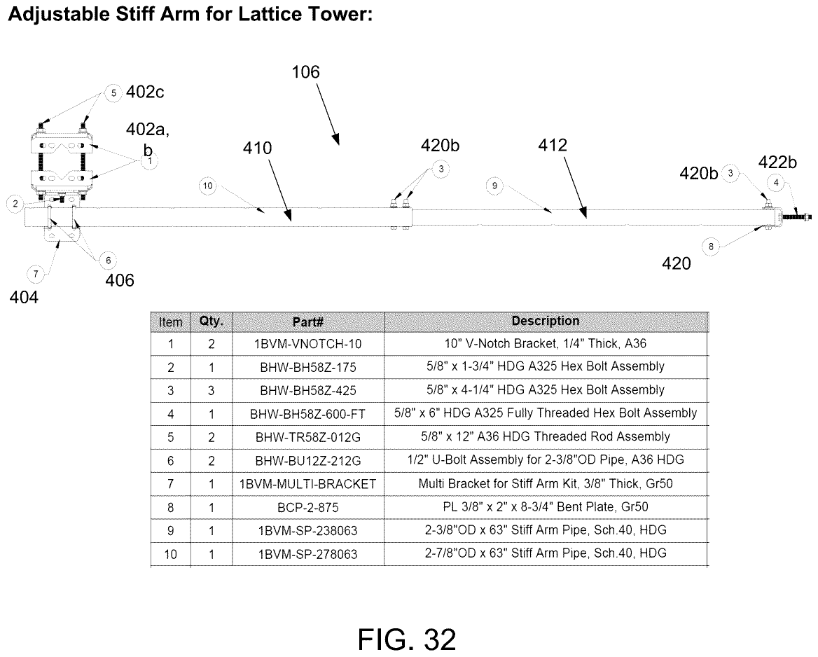

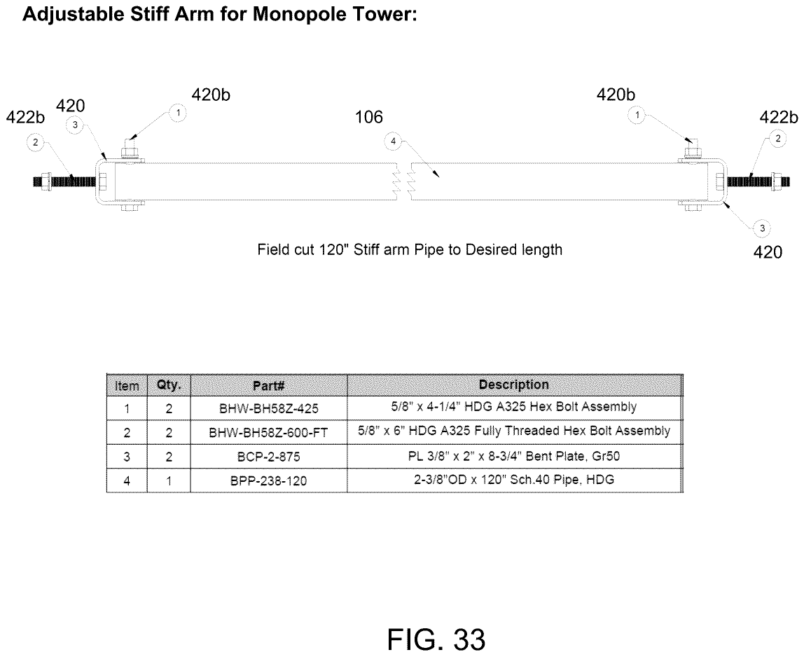

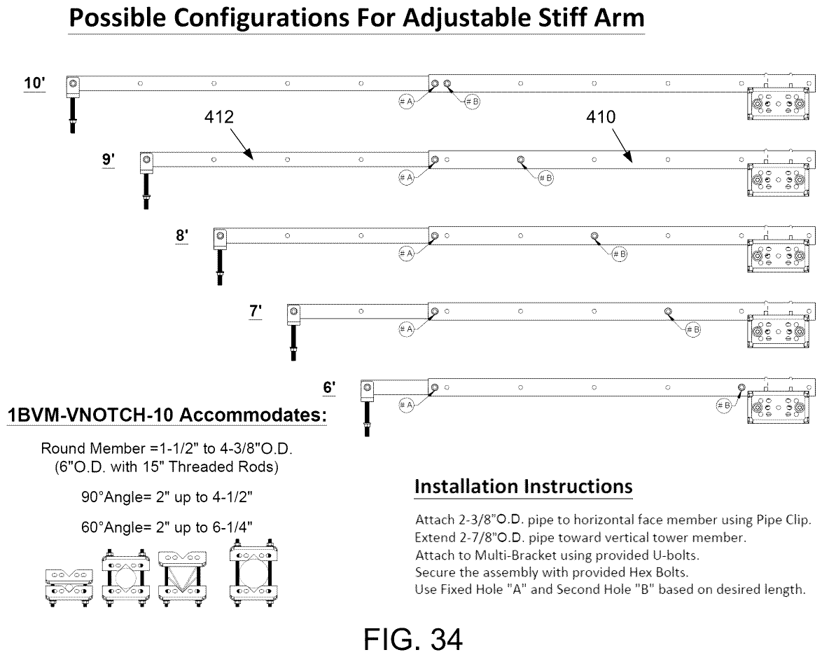

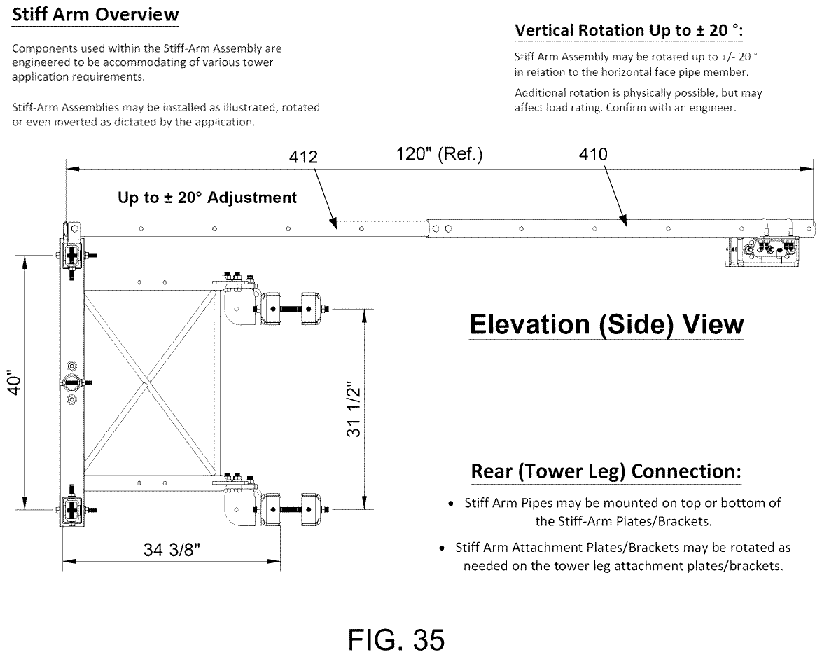

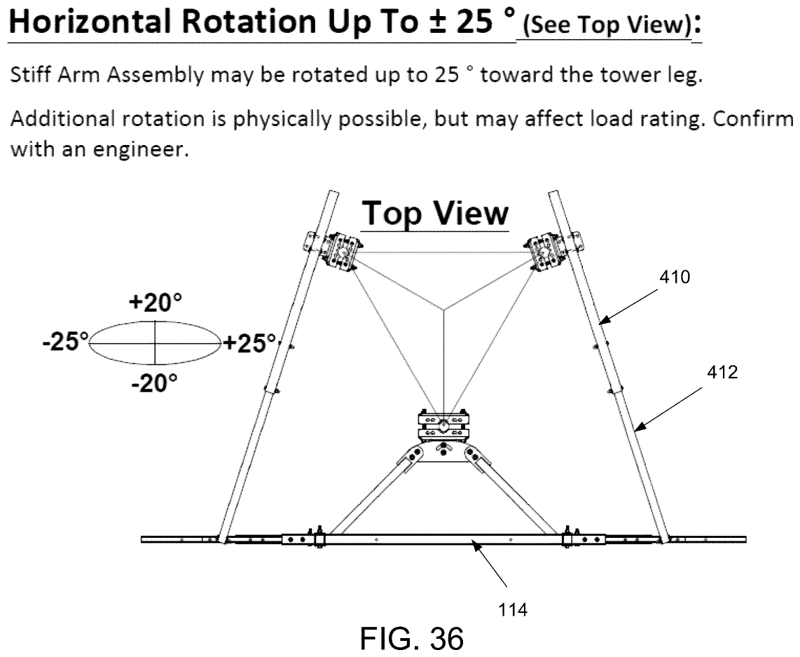

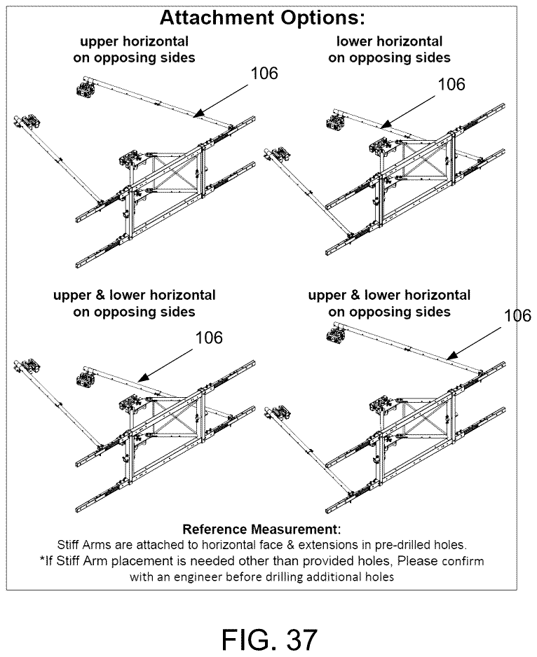

Adjustable stiff arms 106 are used to provide additional support to hold the mount and the antenna in place on the tower structure, as seen in FIGS. 32-37. The arm may be adjustable in length, with one component 412 sliding into and out of another component 410, with the desired length established and fixed by use of hex bolt assemblies 420b. For an adjustable stiff arm for used with a lattice tower, one end is attached to a V-notch bracket 402a, b secured together by hex bolt assembly 402c, by a multi-bracket 404 with U-bolt assembly 406 for securing pipe. The other end comprises a bent plate 420 attached to the arm by hex bolt assembly 420b, with a fully-threaded hex bolt assembly 422b extending from the bent plate 420 for attached to a component of the face assembly. FIG. 33 shows a version of stiff arm for use with a monopole tower. Stiff arms are adaptable, can be rotated horizontally and vertically, and can be configured to fit in a variety of configurations and arrangements.

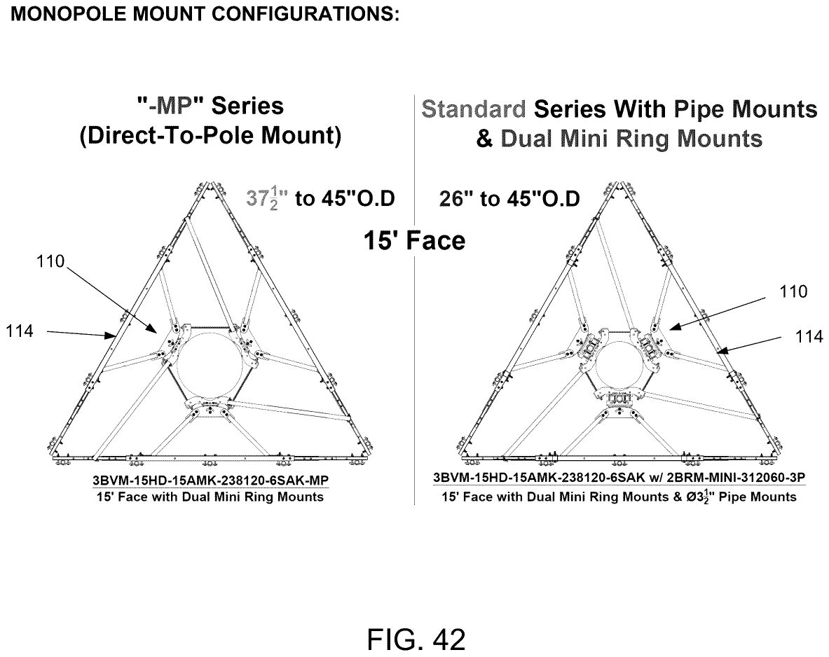

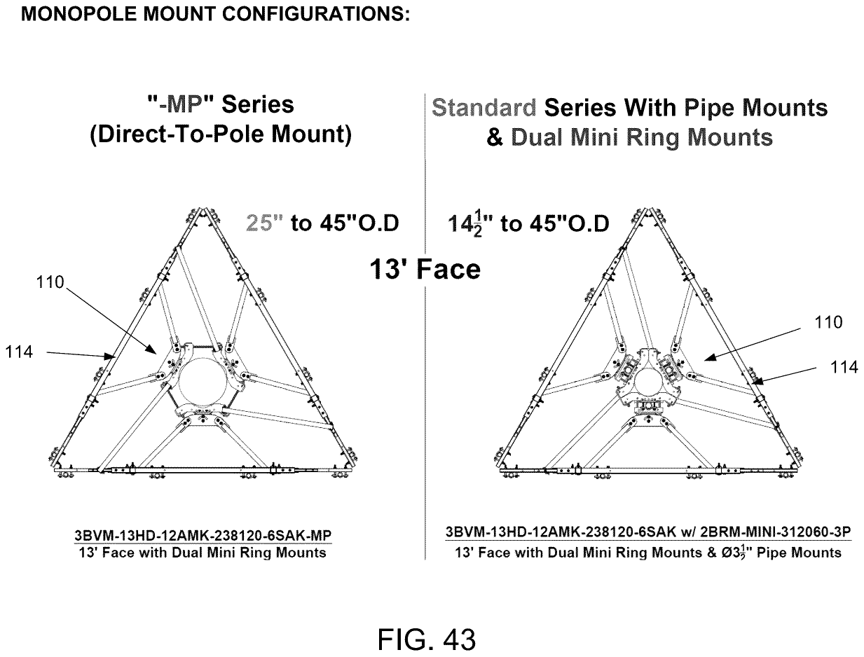

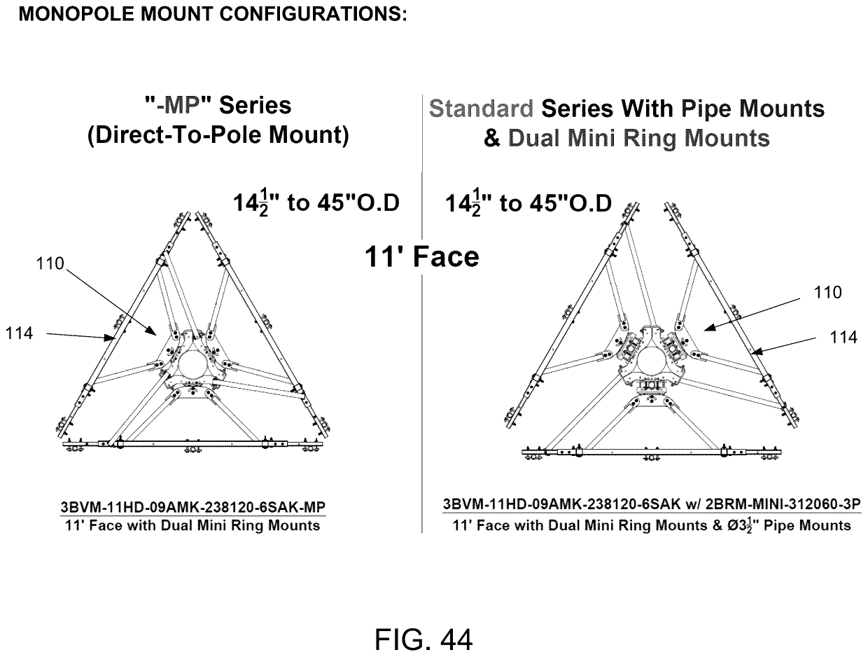

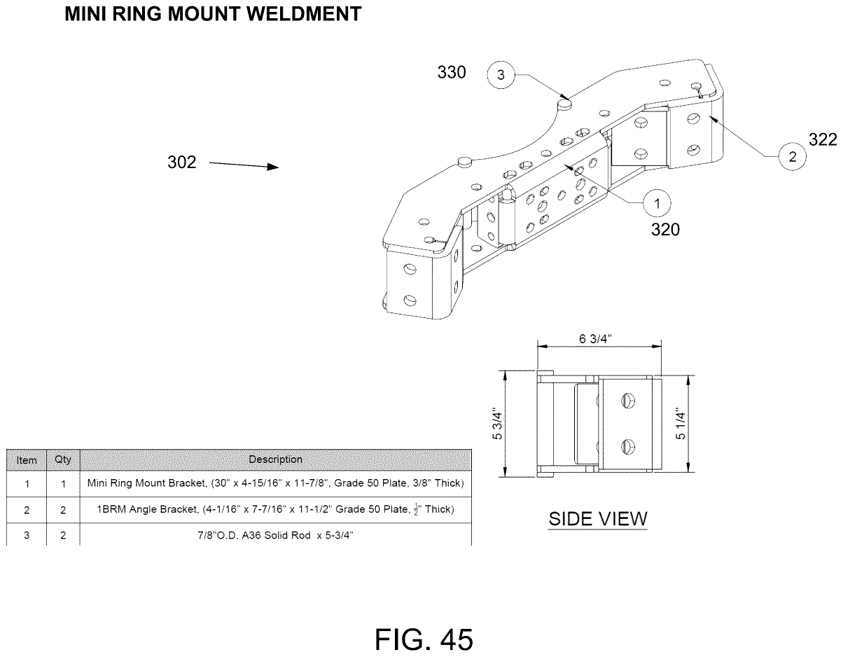

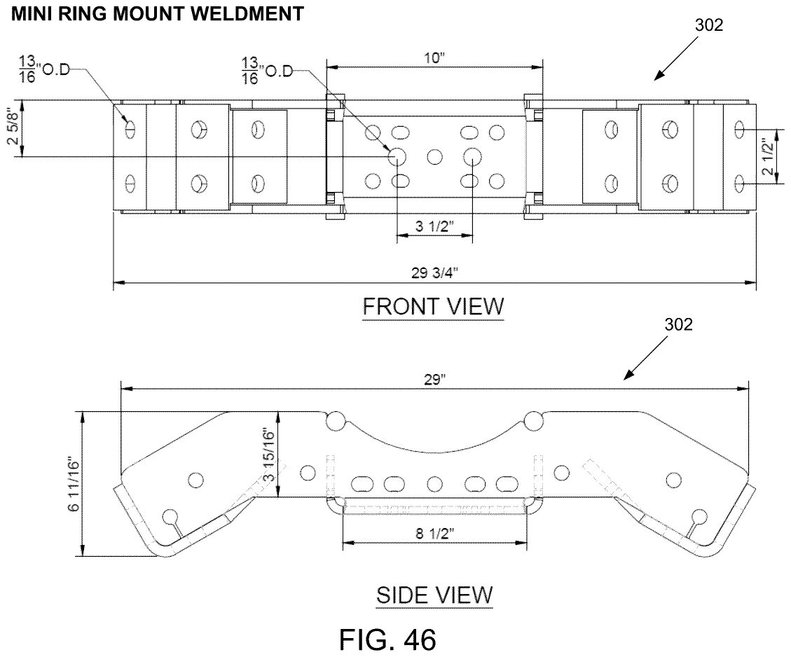

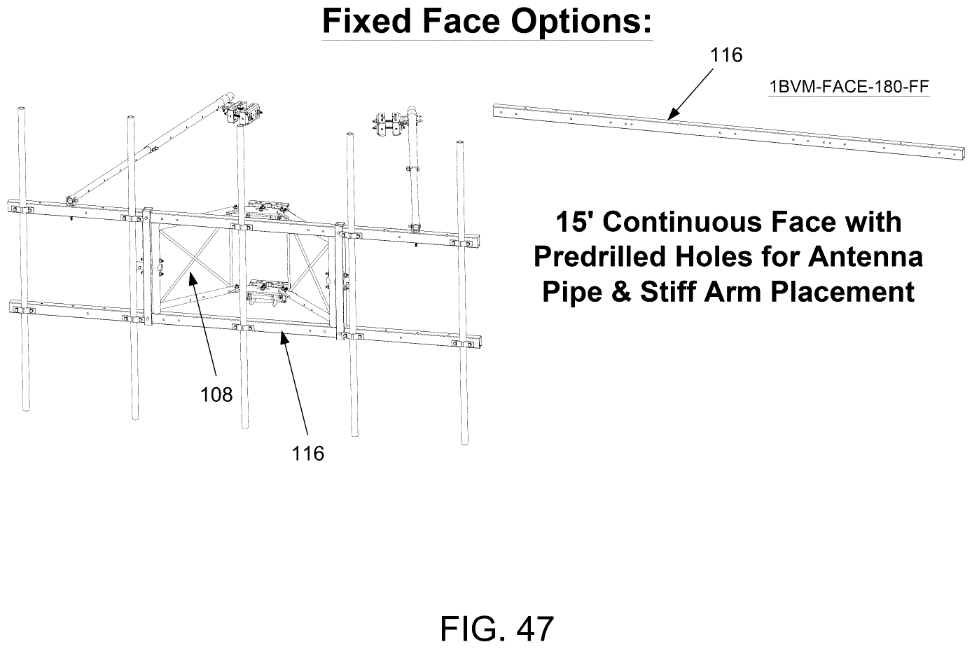

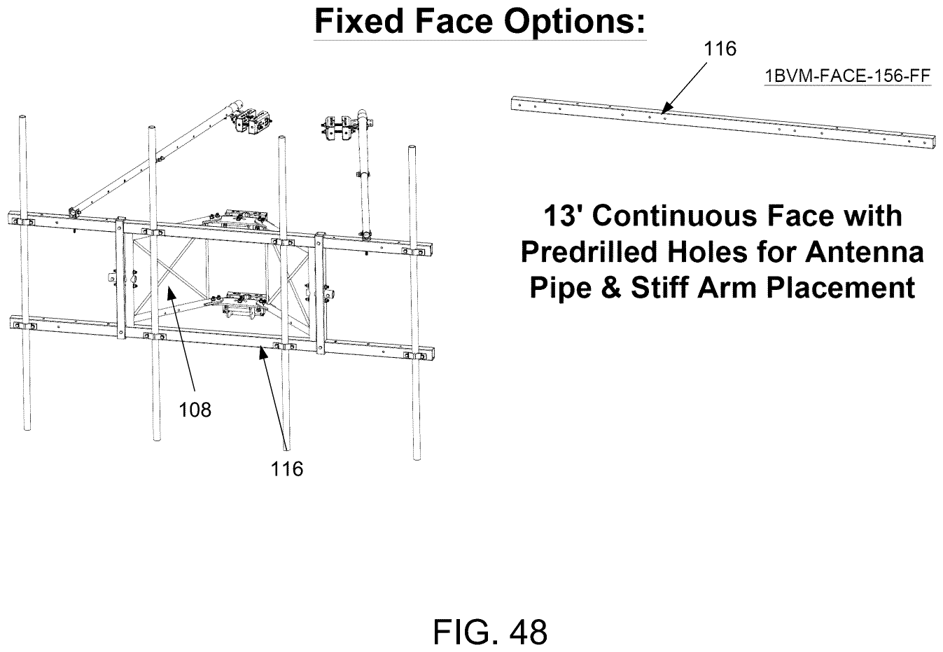

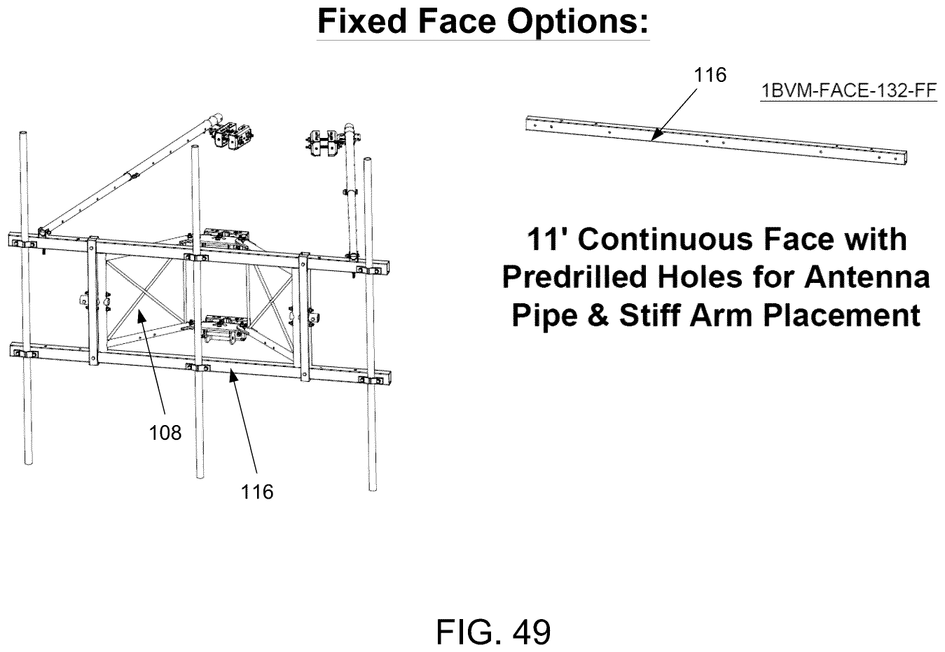

FIGS. 42-49 show various arrangements and options for using the mini-ring mount weldments, attachment brackets, face tubes, and stiff arms to form various mount and face configurations.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An antenna mount for a cellular tower or monopole structure, comprising:
a pair of V-mount bases configured to be attached to the tower or structure by brackets or a mini-ring mount, wherein each base comprises a swivel combo bracket with a boomerang plate rotatably attached to an upper surface;
a pair of V-frame weldments extending outward from the ends of respective boomerang plates to a V-mount face frame; and
two or more antenna mounting pipes vertically attached to the V-mount face frame.

2. The antenna mount of claim 1, further comprising at least one stiff support arm fastened at one end to the V-mount face frame.

3. The antenna mount of claim 1, each V-frame weldment comprising a top pipe and bottom pipe, each connected at their proximal end to a vertical rod extending therebetween, and connected at their distal end to a vertical front pipe extending therebetween;
wherein the top pipe and bottom pipe are connected at their proximal ends to a corresponding end of respective boomerang plates; and
wherein the vertical front pipe comprises a short angle pipe extending from center portion thereof.

4. The antenna mount of claim 3, where the V-mount face frame comprises two parallel vertical face braces each with a top end and bottom end, a top horizontal face tube attached to the top ends of the vertical face braces, and a bottom horizontal face tube attached to the bottom ends of the vertical face braces.

5. The antenna mount of claim 4, wherein each vertical face brace comprises a circular hole extending through the central portion of the brace and parallel to the top and bottom horizontal face tubes.

6. The antenna mount of claim 5, wherein each vertical face brace is rotatably mounted on the corresponding short angle pipe.

7. The antenna mount of claim 6, wherein the boomerang plates can be swiveled from side to side up to 36 degrees from a neutral position, thereby causing the V-mount face frame to swivel correspondingly.

8. The antenna mount of claim 7, wherein the boomerang plates cannot be tilted vertically.

9. The antenna mount of claim 7, wherein the vertical face braces can be rotated up or down up to 7 degrees from a neutral position, thereby causing the V-mount face frame to tilt accordingly.
